(19) United States
(12) Patent Application Publication
(10) Pub. No.: US 2007/0276106 A1
(43) Pub. Date: Nov. 29, 2007

(54) Polymerization process using spray-dried catalyst

(76) Inventors: Phuong Anh Cao, Old Bridge, NJ (US); Sun-Chueh Kao, Hillsborough, NJ (US)

Correspondence Address: Univation Technologies LLC;Suite 1950, 5555 San Felipe, Housteo, TX, 77056, US

(21) Appl. No.: 11/820,408

(22) Filed: Jun. 19, 2007

Related U.S. Application Data
(63) Continuation of application No. 11/168,112, filed on Jun. 28, 2005.
(63) Continuation-in-part of application No. 10/883,551, filed on Jul. 1, 2004.
Application No. 10/883,551 is a continuation of application No. 10/696,680, filed on Oct. 29, 2003, now abandoned.
Application No. 10/696,680 is a division of application No. 09/808,609, filed on Mar. 14, 2001.
Application No. 09/808,609 is a division of application No. 09/207,213, filed on Dec. 8, 1998, now Pat. No. 6,248,845.
Application No. 09/207,213 is a continuation-in-part of application No. 08/986,696, filed on Dec. 8, 1997, now Pat. No. 6,242,545.

(51) Int. Cl. C08F 4/609

(52) U.S. Cl. 526/183

(57) ABSTRACT

A polymerization process for producing polyolefins, which process employs a spray-dried catalyst composition, is provided. An example of a process is a gas phase process for making polyolefins, including: (a) forming a suspension comprising (i) a metallocene catalyst, (ii) an activator; and (iii) a support material, in a diluent; (b) spray-drying the suspension to form a catalyst composition; and (c) contacting the catalyst composition with ethylene and at least one comonomer selected from the group consisting of C4 to C8 alpha olefins in the fluidized bed of a gas-phase reactor for a time sufficient to form a polyolefin composition, wherein an external co-catalyst is absent or substantially absent from the gas-phase reactor.

### CROSS REFERENCE TO RELATED APPLICATIONS

This application is:

a continuation of Ser. No. 11/168,112, filed Jun. 28, 2005; and

a continuation-in-part of Ser. No. 10/883,551, filed Jul. 1, 2004, which is a continuation of Ser. No. 10/696,680, filed Oct. 29, 2003, now abandoned, which is divisional of Ser. No. 09/808,609, filed Mar. 14, 2001, now abandoned, which is a divisional of Ser. No. 09/207,213, filed Dec. 8, 1998, now U.S. Pat. No. 6,248,845, which is a continuation-in-part of Ser. No. 08/986,696, filed Dec. 8, 1997, issued as U.S. Pat. No. 6,242,545, now pending as a reissue application, Ser. No. 11/073,392, filed Mar. 4, 2005;

the disclosures of which are incorporated by reference in their entireties.

### FIELD OF INVENTION

The present invention relates to processes for producing polyolefins, and more particularly, to a polymerization process for producing polyolefins that employs a spray-dried catalyst composition.

### BACKGROUND

Advances in metallocene-based olefin polymerization have resulted in the ability to produce many new polymers having improved properties useful in a wide variety of applications. However, as with any new technology, particularly in the polyolefins industry, a small cost savings may determine the feasibility of a commercial endeavor. The industry has been extremely focused on developing new and improved catalyst systems. Some have focused on designing the catalyst systems to produce new polymers, others on improved operability, and many more on improving catalyst activity. The productivity of a catalyst, e.g., the amount of polymer produced per gram of the catalyst, usually is the key economic factor that can make or break a new commercial development in the polyolefin industry.

One attempt at providing high-productivity catalysts for polyolefin production has involved the use of spray-dried catalyst compositions. An example of a conventional polymerization process that uses spray-dried catalyst compositions is described in U.S. Pat. No. 5,674,795. Notably, the polymerization process described therein involves the use of an external co-catalyst, which is placed in contact with a spray-dried catalyst composition before the spray-dried catalyst composition is fed to a polymerization reactor. However, the use of an external co-catalyst in polyolefin manufacturing may be problematic, for a number of reasons. For example, the external co-catalyst often may be stored separately from the catalyst composition, which may require that an additional storage tank, pump, piping, and instrumentation be provided. This may increase the complexity and cost of the polyolefin production process. As another example, many external co-catalysts are relatively expensive, and their use thus may increase the cost of the polyolefin production process.

Thus, a polyolefin production process that used a spray-dried catalyst composition, but that did not require the use of an external co-catalyst, would be desirable.

### SUMMARY

It has now been found that spray dried metallocene-containing catalyst compositions that contain an inert support may be used in polymerization processes without the need for an external co-catalyst, and may demonstrate desirable productivity as well as good particle integrity and morphology. These catalyst compositions produce polymer particles having desirable sphericity and narrow particle size distributions.

In one embodiment, the invention provides a gas phase process for making polyolefins, comprising: (a) forming a suspension comprising (i) a metallocene catalyst, (ii) an activator; and (iii) a support material, in a diluent; (b) spray-drying the suspension to obtain a catalyst composition; and (c) contacting the catalyst composition with ethylene and at least one comonomer selected from the group consisting of C4 to C8 alpha olefins in the fluidized bed of a gas-phase reactor for a time sufficient to form a polyolefin composition, wherein an external co-catalyst is absent or substantially absent from the gas-phase reactor.

### DESCRIPTION OF THE DRAWING

FIG. 1 is a schematic of a spray drying apparatus for making the spray dried, filled catalyst composition.

### DETAILED DESCRIPTION

The present invention provides a gas phase process for making polyolefins. A suspension is formed that comprises (i) a metallocene catalyst, (ii) an activator; and (iii) a support material, in a diluent. In certain embodiments of the present invention, the suspension may comprise, in addition to the metallocene catalyst, one or more second catalysts. Such optional second catalysts may be, for example and without limitation, metallocene catalysts, or nonmetallocene single-site catalysts. In certain embodiments of the present invention, the optional second catalysts may comprise Ziegler-Natta catalysts containing a metal from Groups IV(B), V(B), or VI(B) of the Periodic Table. Suitable activators for Ziegler-Natta catalysts are well known in the art and also may be included in the catalyst composition.

As used herein, the phrase “catalyst compound” includes any compound that, once appropriately activated, is capable of catalyzing the polymerization or oligomerization of olefins, the catalyst compound comprising at least one Group 3 to Group 12 atom, and optionally at least one leaving group bound thereto.

As used herein, the phrase “leaving group” refers to one or more chemical moieties bound to the metal center of the catalyst component that can be abstracted from the catalyst component by an activator, thus producing the species active towards olefin polymerization or oligomerization. The activator is described further below.

As used herein, the term “substituted” means that the group following that term possesses at least one moiety in place of one or more hydrogens in any position, the moieties selected from such groups as halogen radicals (esp., Cl, F, Br), hydroxyl groups, carbonyl groups, carboxyl groups, amine groups, phosphine groups, alkoxy groups, phenyl groups, naphthyl groups, C₁ to C₁₀ alkyl groups, C₂ to C₁₀ alkenyl groups, and combinations thereof. Examples of substituted alkyls and aryls includes, but are not limited to, acyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl- carbamoyl radicals, acyloxy radicals, acylamino radicals, arylamino radicals, and combinations thereof.

As used herein, structural formulas are employed as is commonly understood in the chemical arts; lines (“ [symbol] ”) used to represent associations between a metal atom (“M”, Group 3 to Group 12 atoms) and a ligand or ligand atom (e.g., cyclopentadienyl, nitrogen, oxygen, halogen ions, alkyl, etc.), as well as the phrases “associated with”, “bonded to” and “bonding”, are not limited to representing a certain type of chemical bond, as these lines and phrases are meant to represent a “chemical bond”; a “chemical bond” defined as an attractive force between atoms that is strong enough to permit the combined aggregate to function as a unit, or “compound”.

A certain stereochemistry for a given structure or part of a structure should not be implied unless so stated for a given structure or apparent by use of commonly used bonding symbols such as by dashed lines and/or heavy lines.

Unless stated otherwise, no embodiment of the present invention is herein limited to the oxidation state of the metal atom “M” as defined below in the individual descriptions and examples that follow. The ligation of the metal atom “M” is such that the compounds described herein are neutral, unless otherwise indicated.

As referred to herein, the term “external co-catalyst” will be understood to mean a compound that is contacted with a catalyst compound, so as to activate the catalyst compound, before the catalyst compound is contacted with co-monomers in a reactor. Examples of external co-catalysts may include TIBA and MMAO, among others.

Metallocene Catalyst Compounds

The catalyst system useful in the present invention includes at least one metallocene catalyst component as described herein. Metallocene catalyst compounds are generally described throughout in, for example, 1 & 2 METALLOCENE-BASED POLYOLEFINS (John Scheirs & W. Kaminsky eds., John Wiley & Sons, Ltd. 2000); G. G. Hlatky in 181 COORDINATION CHEM. REV. 243-296 (1999) and in particular, for use in the synthesis of polyethylene in 1 METALLOCENE-BASED POLYOLEFINS 261-377 (2000). The metallocene catalyst compounds as described herein include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom. Hereinafter, these compounds will be referred to as “metallocenes” or “metallocene catalyst components”. The metallocene catalyst component is supported on a support material, in a particular exemplary embodiment as described further below, and may be supported with, or without, another catalyst component.

The Cp ligands are one or more rings or ring system(s), at least a portion of which includes π-bonded systems, such as cycloalkadienyl ligands and heterocyclic analogues. The ring(s) or ring system(s) typically comprise atoms selected from the group consisting of Groups 13 to 16 atoms, and, in a particular exemplary embodiment, the atoms that make up the Cp ligands are selected from the group consisting of carbon, nitrogen, oxygen, silicon, sulfur, phosphorous, germanium, boron and aluminum and combinations thereof, wherein carbon makes up at least 50% of the ring members. In a more particular exemplary embodiment, the Cp ligand(s) are selected from the group consisting of substituted and unsubstituted cyclopentadienyl ligands and ligands isolobal to cyclopentadienyl, non-limiting examples of which include cyclopentadienyl, indenyl, fluorenyl and other structures. Further non-limiting examples of such ligands include cyclopentadienyl, cyclopentaphenanthreneyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄Ind”), substituted versions thereof (as described in more detail below), and heterocyclic versions thereof.

The metal atom “M” of the metallocene catalyst compound, as described throughout the specification and claims, may be selected from the group consisting of Groups 3 through 12 atoms and lanthanide Group atoms in one exemplary embodiment; and selected from the group consisting of Groups 3 through 10 atoms in a more particular exemplary embodiment, and selected from the group consisting of Sc, Ti, Zr, Hf, V, Nb, Ta, Mn, Re, Fe, Ru, Os, Co, Rh, Ir, and Ni in yet a more particular exemplary embodiment; and selected from the group consisting of Groups 4, 5 and 6 atoms in yet a more particular exemplary embodiment, and Ti, Zr, Hf atoms in yet a more particular exemplary embodiment, and Zr in yet a more particular exemplary embodiment. The oxidation state of the metal atom “M” may range from 0 to +7 in one exemplary embodiment; and in a more particular exemplary embodiment, may be +1, +2, +3, +4 or +5; and in yet a more particular exemplary embodiment may be +2, +3 or +4. The groups bound to the metal atom “M” are such that the compounds described below in the formulas and structures are electrically neutral, unless otherwise indicated. The Cp ligand(s) form at least one chemical bond with the metal atom M to form the “metallocene catalyst compound”. The Cp ligands are distinct from the leaving groups bound to the catalyst compound in that they are not highly susceptible to substitution/abstraction reactions.

In one aspect of the invention, the one or more metallocene catalyst components of the invention are represented by the formula (I):
Cp^{A}Cp^{B}MXₙ (I)
wherein M is as described above;

each X is chemically bonded to M;

each Cp group is chemically bonded to M; and

n is 0 or an integer from 1 to 4, and either 1 or 2 in a particular exemplary embodiment.

The ligands represented by Cp^{A} and Cp^{B} in formula (I) may be the same or different cyclopentadienyl ligands or ligands isolobal to cyclopentadienyl, either or both of which may contain heteroatoms and either or both of which may be substituted by a group R. In one exemplary embodiment, Cp^{A} and Cp^{B} are independently selected from the group consisting of cyclopentadienyl, indenyl, tetrahydroindenyl, fluorenyl, and substituted derivatives of each.

Independently, each Cp^{A} and Cp^{B} of formula (I) may be unsubstituted or substituted with any one or combination of substituent groups R. Non-limiting examples of substituent groups R as used in structure (I) as well as ring substituents in structures (Va-d) include groups selected from the group consisting of hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof. More particular non-limiting examples of alkyl substituents R associated with formulas (I) through (Va-d) include methyl, ethyl, propyl, butyl, pentyl, hexyl, cyclopentyl, cyclohexyl, benzyl, phenyl, methylphenyl, and tert-butylphenyl groups and the like, including. all their isomers, for example, tertiary-butyl, isopropyl, and the like. Other possible radicals include substituted alkyls and aryls such as, for example, fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals, including tris(trifluoromethyl)silyl, methylbis(difluoromethyl)silyl, bromomethyldimethylgermyl and the like; and disubstituted boron radicals including dimethylboron, for example; and disubstituted Group 15 radicals including dimethylamine, dimethylphosphine, diphenylamine, methylphenylphosphine, as well as Group 16 radicals including methoxy, ethoxy, propoxy, phenoxy, methylsulfide and ethylsulfide. Other substituents R include, but are not limited to, olefins such as olefinically unsaturated substituents including vinyl-terminated ligands such as, for example, 3-butenyl, 2-propenyl, 5-hexenyl and the like. In one exemplary embodiment, at least two R groups (two adjacent R groups in a particular exemplary embodiment) are joined to form a ring structure having from 3 to 30 atoms selected from the group consisting of carbon, nitrogen, oxygen, phosphorous, silicon, germanium, aluminum, boron and combinations thereof. Also, a substituent group R group such as 1-butanyl may form a bonding association to the element M.

Each X in the formula (I) above and for the formulae/structures (II) through (Va-d) below is independently selected from the group consisting of: any leaving group, in one exemplary embodiment; halogen ions, hydrides, C, to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₁₈ alkylaryloxys, C₁ to C₁₂ fluoroalkyls, C₆ to C₁₂ fluoroaryls, and C₁ to C₁₂ heteroatom-containing hydrocarbons and substituted derivatives thereof in a more particular exemplary embodiment; hydride, halogen ions, C₁ to C₆ alkyls, C₂ to C₆ alkenyls, C₇ to C₁₈ alkylaryls, C₁ to C₆ alkoxys, C₆ to C₁₄ aryloxys, C₇ to C₁₆ alkylaryloxys, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls, and C₇ to C₁₈ fluoroalkylaryls in yet a more particular exemplary embodiment; hydride, chloride, fluoride, methyl, phenyl, phenoxy, benzoxy, tosyl, fluoromethyls and fluorophenyls in yet a more particular exemplary embodiment; C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls and C₁ to C₁₂ heteroatom-containing alkyls, C₁ to C₁₂ heteroatom-containing aryls and C₁ to C₁₂ heteroatom-containing alkylaryls in yet a more particular exemplary embodiment; chloride, fluoride, C₁ to C₆ alkyls, C₂ to C₆ alkenyls, C₇ to C₁₈ alkylaryls, halogenated C₁ to C₆ alkyls, halogenated C₂ to C₆ alkenyls, and halogenated C₇ to C₁₈ alkylaryls in yet a more particular exemplary embodiment; fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls) in yet a more particular exemplary embodiment; and fluoride in yet a more particular exemplary embodiment.

Other non-limiting examples of X groups include amines, phosphines, ethers, carboxylates, dienes, hydrocarbon radicals having from 1 to 20 carbon atoms, fluorinated hydrocarbon radicals (e.g., —C₆F₅ (pentafluorophenyl)), fluorinated alkylcarboxylates (e.g., CF₃C(O)O—), hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In one exemplary embodiment, two or more X's form a part of a fused ring or ring system.

In another aspect of the invention, the metallocene catalyst component includes those of formula (I) where Cp^{A} and Cp^{B} are bridged to each other by at least one bridging group, (A), such that the structure is represented by formula (II):
Cp^{A}(A)Cp^{B}MXₙ (II)
These bridged compounds represented by formula (II) are known as “bridged metallocenes”. The elements Cp^{A}, Cp^{B}, M, X and n in structure (II) are as defined above for formula (I); wherein each Cp ligand is chemically bonded to M, and (A) is chemically bonded to each Cp. Non-limiting examples of bridging group (A) include divalent hydrocarbon groups containing at least one Group 13 to 16 atom, such as, but not limited to, at least one of a carbon, oxygen, nitrogen, silicon, aluminum, boron, germanium and tin atom and combinations thereof; wherein the heteroatom may also be C₁ to C₁₂ alkyl or aryl substituted to satisfy neutral valency. The bridging group (A) may also contain substituent groups R as defined above (for formula (I)) including halogen radicals and iron. More particular non-limiting examples of bridging group (A) are represented by C₁ to C₆ alkylenes, substituted C₁ to C₆ alkylenes, oxygen, sulfur, R′₂C═, R′₂Si═, ═Si(R′)₂Si(R′₂)=, R′₂Ge═, and R′P═(wherein “=” represents two chemical bonds), where R′ is independently selected from the group consisting of hydride, hydrocarbyl, substituted hydrocarbyl, halocarbyl, substituted halocarbyl, hydrocarbyl-substituted organometalloid, halocarbyl-substituted organometalloid, disubstituted boron, disubstituted Group 15 atoms, substituted Group 16 atoms, and halogen radical; and wherein two or more R′ may be joined to form a ring or ring system. In one exemplary embodiment, the bridged metallocene catalyst component of formula (II) has two or more bridging groups (A).

Other non-limiting examples of bridging group (A) include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties wherein the Si atom is replaced by a Ge or a C atom; as well as dimethylsilyl, diethylsilyl, dimethylgermyl and diethylgermyl.

In another exemplary embodiment, bridging group (A) may also be cyclic, having, for example, 4 to 10 ring members; in a more particular exemplary embodiment, bridging group (A) may have 5 to 7 ring members. The ring members may be selected from the elements mentioned above, and, in a particular exemplary embodiment, are selected from one or more of B, C, Si, Ge, N and O. Non-limiting examples of ring structures which may be present as, or as part of, the bridging moiety are cyclobutylidene, cyclopentylidene, cyclohexylidene, cycloheptylidene, cyclooctylidene and the corresponding rings where one or two carbon atoms are replaced by at least one of Si, Ge, N and O. In a more particular exemplary embodiment, one or two carbon atoms are replaced by at least one of Si and Ge. The bonding arrangement between the ring and the Cp groups may be either cis-, trans-, or a combination.

The cyclic bridging groups (A) may be saturated or unsaturated and/or may carry one or more substituents and/or may be fused to one or more other ring structures. If present, the one or more substituents are, in one exemplary embodiment, selected from the group consisting of hydrocarbyl (e.g., alkyl, such as methyl) and halogen (e.g., F, Cl). The one or more Cp groups to which the above cyclic bridging moieties may optionally be fused may be saturated or unsaturated, and are selected from the group consisting of those having 4 to 10, more particularly 5, 6 or 7 ring members (selected from the group consisting of C, N, O and S in a particular exemplary embodiment) such as, for example, cyclopentyl, cyclohexyl and phenyl. Moreover, these ring structures may themselves be fused such as, for example, in the case of a naphthyl group. Moreover, these (optionally fused) ring structures may carry one or more substituents. Illustrative, non-limiting examples of these substituents are hydrocarbyl (particularly alkyl) groups and halogen atoms.

The ligands Cp^{A} and Cp^{B} of formulae (I) and (II) are different from each other in one exemplary embodiment, and the same in another exemplary embodiment.

In yet another aspect of the invention, the metallocene catalyst components include bridged mono-ligand metallocene compounds (e.g., mono cyclopentadienyl catalyst components). In this embodiment, the at least one metallocene catalyst component is a bridged “half-sandwich” metallocene represented by the formula (III):
Cp^{A}(A)QMXᵣ (III)
wherein Cp^{A} is defined above and is bound to M;

(A) is a bridging group bonded to Q and Cp^{A}; and

an atom from the Q group is bonded to M; and r is an integer 0, 1 or 2.

In formula (III) above, Cp^{A}, (A) and Q may form a fused ring system. The X groups of formula (III) are as defined above in formula (I) and (II). In one exemplary embodiment, Cp^{A} is selected from the group consisting of cyclopentadienyl, indenyl, tetrahydroindenyl, fluorenyl, substituted versions thereof, and combinations thereof.

In formula (III), Q is a heteroatom-containing ligand in which the bonding atom (the atom that is bonded with the metal M) is, in one exemplary embodiment, selected from the group consisting of Group 15 atoms and Group 16 atoms. In yet a more particular embodiment, the bonding atom is selected from the group consisting of nitrogen, phosphorus, oxygen or sulfur atoms. In still a more particular embodiment, the bonding atom is selected from the group consisting of nitrogen and oxygen. Non-limiting examples of Q groups include alkylamines, arylamines, mercapto compounds, ethoxy compounds, carboxylates (e.g., pivalate), carbamates, azenyl, azulene, pentalene, phosphoyl, phosphinimine, pyrrolyl, pyrozolyl, carbazolyl, borabenzene other compounds having Group 15 and Group 16 atoms capable of bonding with M.

In yet another aspect of the invention, the at least one metallocene catalyst component is an unbridged “half sandwich” metallocene represented by the formula (IVa):
Cp^{A}MQ_{q}X_{w} (IVa)
wherein Cp^{A} is defined as for the Cp groups in (I) and is a ligand that is bonded to M;

each Q is independently bonded to M;

X is a leaving group as described above in (I);

w ranges from 0 to 3, and is 0 or 3 in one exemplary embodiment;

q ranges from 0 to 3, and is 0 or 3 in one exemplary embodiment.

In one exemplary embodiment, Cp^{A} is selected from the group consisting of cyclopentadienyl, indenyl, tetrahydroindenyl, fluorenyl, substituted version thereof, and combinations thereof. In formula (IVa), Q is selected from the group consisting of ROO⁻, RO—, R(O)—, —NR—, —CR₂—, —S—, —NR₂, —CR₃, —SR, —SiR₃, —PR₂, —H, and substituted and unsubstituted aryl groups, R is selected from the group consisting of C₁ to C₆ alkyls, C₆ to C₁₂ aryls, C₁ to C₆ alkylamines, C₆ to C₁₂ alkylarylamines, C₁ to C₆ alkoxys, C₆ to C₁₂ aryloxys, and the like. Non-limiting examples of Q include C₁ to C₁₂ carbamates, C₁ to C₁₂ carboxylates (e.g., pivalate), C₂ to C₂₀ allyls, and C₂ to C₂₀ heteroallyl moieties.

Described another way, the “half sandwich” metallocenes above can be described as in formula (IVb), such as described in, for example, U.S. Pat. No. 6,069,213:
Cp^{A}M(W₂GZ)X_{y} or (IVb)
T(Cp^{A}M(W₂GZ)X_{y})ₘ
wherein M, Cp^{A}, and X are as defined above;
W₂GZ forms a polydentate ligand unit (e.g., pivalate), wherein at least one of the W groups form a bond with M, and is defined such that each W is independently selected from the group consisting of —O—, —NR—, —CR₂— and —S—; G is either carbon or silicon; and Z is selected from the group consisting of R, —OR, —NR₂, —CR₃, —SR, —SiR₃, —PR₂, and hydride, providing that when W is —NR—, then Z is selected from the group consisting of —OR, —NR₂, —SR, —SiR₃, —PR₂; and provided that neutral valency for W is satisfied by Z; and wherein each R is independently selected from the group consisting of C₁ to C₁₀ heteroatom containing groups, C₁ to C₁₀ alkyls, C₆ to C₁₂ aryls, C₆ to C₁₂ alkylaryls, C₁ to C₁₀ alkoxys, and C₆ to C₁₂ aryloxys;

y is 1 or 2 in a particular embodiment;

T is a bridging group selected from the group consisting of C₁ to C₁₀ alkylenes, C₆ to C₁₂ arylenes and C₁ to C₁₀ heteroatom containing groups, and C₆ to C₁₂ heterocyclic groups; wherein each T group bridges adjacent Cp^{A}M(W₂GZ)X_{y} groups, and is chemically bonded to the Cp^{A} groups; and

m is an integer from 1 to 7. In an exemplary embodiment, m is an integer from 2 to 6.

In another aspect of the invention, the metallocene catalyst component can be described more particularly in structures (Va), (Vb), (Vc) and (Vd): 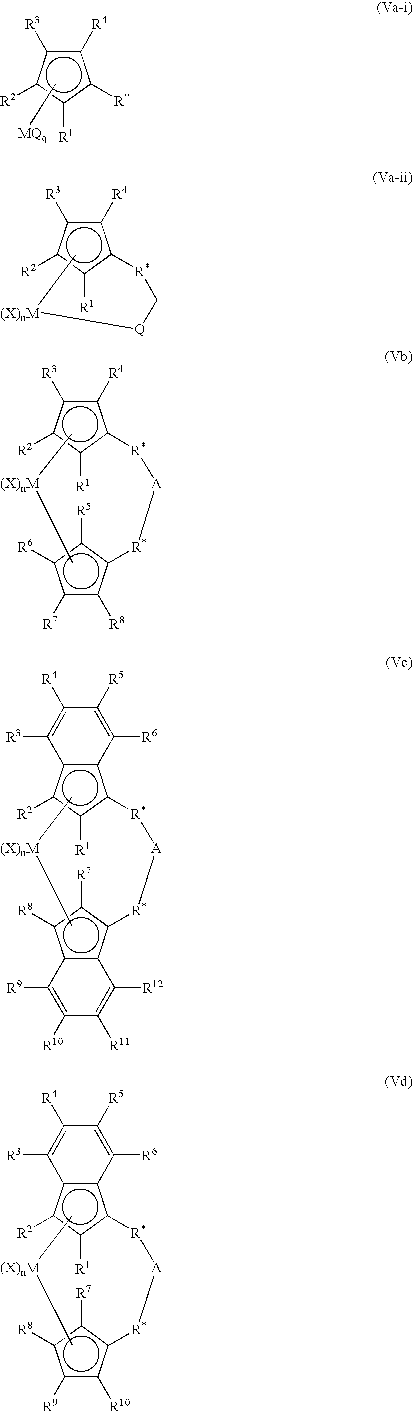
wherein in structures (Va) to (Vd) M is selected from the group consisting of Group 3 to Group 12 atoms, and selected from the group consisting of Group 3 to Group 10 atoms in a more particular embodiment, and selected from the group consisting of Group 3 to Group 6 atoms in yet a more particular embodiment, and selected from the group consisting of Group 4 atoms in yet a more particular embodiment, and selected from the group consisting of Zr and Hf in yet a more particular embodiment; and is Zr in yet a more particular embodiment; wherein Q in (Va-i) and (Va-ii) is selected from the group consisting of halogen ions, alkyls, alkylenes, aryls, arylenes, alkoxys, aryloxys, amines, alkylamines, phosphines, alkylphosphines, substituted alkyls, substituted aryls, substituted alkoxys, substituted aryloxys, substituted amines, substituted alkylamines, substituted phosphines, substituted alkylphosphines, carbamates, heteroallyls, carboxylates (non-limiting examples of suitable carbamates and carboxylates include trimethylacetate, trimethylacetate, methylacetate, p-toluate, benzoate, diethylcarbamate, and dimethylcarbamate), fluorinated alkyls, fluorinated aryls, and fluorinated alkylcarboxylates; q is an integer ranging from 1 to 3;
wherein each R* is independently: selected from the group consisting of hydrocarbyls and heteroatom-containing hydrocarbyls in one exemplary embodiment; and selected from the group consisting of alkylenes, substituted alkylenes and heteroatom-containing hydrocarbyls in another exemplary embodiment; and selected from the group consisting of C₁ to C₁₂ alkylenes, C₁ to C₁₂ substituted alkylenes, and C₁ to C₁₂ heteroatom-containing hydrocarbons in a more particular embodiment; and selected from the group consisting of C₁ to C₄ alkylenes in yet a more particular embodiment; and wherein both R* groups are identical in another exemplary embodiment in structures (Vb-d);

A is as described above for (A) in structure (II), and more particularly, selected from the group consisting of —O—, —S—, —SO₂—, —NR—, ═SiR₂, ═GeR₂, ═SnR₂, —R₂SiSiR₂—, RP═, C₁ to C₁₂ alkylenes, substituted C₁ to C₁₂ alkylenes, divalent C₄ to C₁₂ cyclic hydrocarbons and substituted and unsubstituted aryl groups in one exemplary embodiment; and selected from the group consisting of C₅ to C₈ cyclic hydrocarbons, —CH₂CH₂—, ═CR₂ and ═SiR₂ in a more particular embodiment; wherein R is selected from the group consisting of alkyls, cycloalkyls, aryls, alkoxys, fluoroalkyls and heteroatom-containing hydrocarbons in one exemplary embodiment; and R is selected from the group consisting of C₁ to C₆ alkyls, substituted phenyls, phenyl, and C₁ to C₆ alkoxys in a more particular embodiment; and R is selected from the group consisting of methoxy, methyl, phenoxy, and phenyl in yet a more particular embodiment;

wherein A may be absent in yet another exemplary embodiment, in which case

each R* is defined as for R¹-R¹²;

each X is as described above in (I);

n is an integer from 0 to 4, and from 1 to 3 in another exemplary embodiment, and 1 or 2 in yet another exemplary embodiment; and

R¹ through R² are independently: selected from the group consisting of hydrogen radical, halogen radicals, C₁ to C₁₂ alkyls, C₂ to C₁₂ alkenyls, C₆ to C₁₂ aryls, C₇ to C₂₀ alkylaryls, C₁ to C₁₂ alkoxys, C₁ to C₁₂ fluoroalkyls, C₆ to C₁₂ fluoroaryls, and C₁ to C₁₂ heteroatom-containing hydrocarbons and substituted derivatives thereof, in one exemplary embodiment; selected from the group consisting of hydrogen radical, fluorine radical, chlorine radical, bromine radical, C₁ to C₆ alkyls, C₂ to C₆ alkenyls, C₇ to C₁₈ alkylaryls, C₁ to C₆ fluoroalkyls, C₂ to C₆ fluoroalkenyls, C₇ to C₁₈ fluoroalkylaryls in a more particular embodiment; and hydrogen radical, fluorine radical, chlorine radical, methyl, ethyl, propyl, isopropyl, butyl, isobutyl, tertiary butyl, hexyl, phenyl, 2,6-di-methylphenyl, and 4-tertiarybutylphenyl groups in yet a more particular embodiment; wherein adjacent R groups may form a ring, either saturated, partially saturated, or completely saturated.

The structure of the metallocene catalyst component represented by (Va) may take on many forms, such as those disclosed in, for example, U.S. Pat. No. 5,026,798, U.S. Pat. No. 5,703,187, and U.S. Pat. No. 5,747,406, including a dimer or oligomeric structure, such as disclosed in, for example, U.S. Pat. No. 5,026,798 and U.S. Pat. No. 6,069,213.

In a particular embodiment of the metallocene represented in (Vd), R¹ and R² form a conjugated 6-membered carbon ring system that may or may not be substituted.

In a preferred embodiment of the present invention, the metallocene catalyst may be represented by the following formula:
Cp₂HfX₂
wherein each Cp is independently a cyclopentadienyl, indenyl or tetrahydroindenyl, characterized in that at least one Cp is substituted with a group selected from the group consisting of halogens, C₁ to C₂₀ alkyls, C₁ to C₂₀ alkoxys, C₅ to C₂₀ arylalkyls, C₅ to C₂₀ alkylaryls, and combinations thereof; and

X is an anionic leaving group.

In another preferred embodiment of the present invention, the metallocene catalyst may be represented by the following formula:
Cp₂HfX₂
wherein Cp is a cyclopentadienyl, characterized in that at least one Cp is substituted with a group selected from the group consisting of halogens, C, to C₁₀ alkyls, C₁ to C₂₀ alkoxys, C₅ to C₂₀ arylalkyls, C₅ to C₂₀ alkylaryls, and combinations thereof; and

X is an anionic leaving group selected from the group consisting of halides and C₁ to C₁₀ alkyls.

Non-limiting examples of metallocene catalyst components consistent with the description herein include:
cyclopentadienylzirconium Xₙ,
indenylzirconium Xₙ,
(1-methylindenyl)zirconium Xₙ,
(2-methylindenyl)zirconium Xₙ,
(1-propylindenyl)zirconium Xₙ,
(2-propylindenyl)zirconium Xₙ,
(1-butylindenyl)zirconium Xₙ,
(2-butylindenyl)zirconium Xₙ,
(methylcyclopentadienyl)zirconium Xₙ,
tetrahydroindenylzirconium Xₙ,
(pentamethylcyclopentadienyl)zirconium Xₙ,
cyclopentadienylzirconium Xₙ,
pentamethylcyclopentadienyltitanium Xₙ,
tetramethylcyclopentyltitanium Xₙ,
1,2,4-trimethylcyclopentadienylzirconium Xₙ,
dimethylsilyl(1,2,3,4-tetramethylcyclopentadienyl)(cyclopentadienyl)zirconium Xₙ,
dimethylsilyl(1,2,3,4-tetramethylcyclopentadienyl)(1 ,2,3-trimethyl-cyclopentadienyl)zirconium Xₙ,
dimethylsilyl(1,2,3,4-tetramethylcyclopentadienyl)(1 ,2-dimethyl-cyclopentadienyl)zirconium Xₙ,
dimethylsilyl(1,2,3,4-tetramethyl-cyclopentadienyl)(2-methylcyclopentadienyl)zirconium Xₙ,
dimethylsilyl(cyclopentadienyl)(indenyl)zirconium Xₙ,
dimethylsilyl(2-methylindenyl)(fluorenyl)zirconium Xₙ,
diphenylsilyl(1,2,3,4-tetramethyl-cyclopentadienyl)(3-propylcyclopentadienyl)zirconium Xₙ,
dimethylsilyl(1,2,3,4-tetramethylcyclopentadienyl) (3-t-butylcyclopentadienyl)zirconium Xₙ,
dimethylgermyl(1,2-dimethylcyclopentadienyl)
(3-isopropylcyclopentadienyl)zirconium Xₙ,
dimethylsilyl(1,2,3,4-tetramethyl-cyclopentadienyl)(3-methylcyclopentadienyl)
zirconium Xₙ,
diphenylmethylidene(cyclopentadienyl)(9-fluorenyl)zirconium Xₙ,
diphenylmethylidene(cyclopentadienyl)(indenyl)zirconium Xₙ,
iso-propylidenebis(cyclopentadienyl)zirconium Xₙ,
iso-propylidene(cyclopentadienyl)(9-fluorenyl)zirconium Xₙ,
iso-propylidene(3-methylcyclopentadienyl)(9-fluorenyl)zirconium Xₙ,
ethylenebis(9-fluorenyl)zirconium Xₙ,
meso-ethylenebis(1-indenyl)zirconium Xₙ,
ethylenebis(1-indenyl)zirconium Xₙ,
ethylenebis(2-methyl-1-indenyl)zirconium Xₙ,
ethylenebis(2-methyl-4,5,6,7-tetrahydro-1-indenyl)zirconium Xₙ,
ethylenebis(2-propyl-4,5,6,7-tetrahydro-1-indenyl)zirconium Xₙ,
ethylenebis(2-isopropyl-4,5,6,7-tetrahydro-1-indenyl)zirconium Xₙ,
ethylenebis(2-butyl-4,5,6,7-tetrahydro-1-indenyl)zirconium Xₙ,
ethylenebis(2-isobutyl-4,5,6,7-tetrahydro-1-indenyl)zirconium Xₙ,
dimethylsilyl(4,5,6,7-tetrahydro-1-indenyl)zirconium Xₙ,
diphenyl(4,5,6,7-tetrahydro-1-indenyl)zirconium Xₙ,
ethylenebis(4,5,6,7-tetrahydro-1-indenyl)zirconium Xₙ,
dimethylsilylbis(cyclopentadienyl)zirconium Xₙ,
dimethylsilylbis(9-fluorenyl)zirconium Xₙ,
dimethylsilylbis(1-indenyl)zirconium Xₙ,
dimethylsilylbis(2-methylindenyl)zirconium Xₙ,
dimethylsilylbis(2-propylindenyl)zirconium Xₙ,
dimethylsilylbis(2-butylindenyl)zirconium Xₙ,
diphenylsilylbis(2-methylindenyl)zirconium Xₙ,
diphenylsilylbis(2-propylindenyl)zirconium Xₙ,
diphenylsilylbis(2-butylindenyl)zirconium Xₙ,
dimethylgermylbis(2-methylindenyl)zirconium Xₙ dimethylsilylbis(tetrahydroindenyl)zirconium Xₙ,
dimethylsilylbis(tetramethylcyclopentadienyl)zirconium Xₙ,
dimethylsilyl(cyclopentadienyl)(9-fluorenyl)zirconium Xₙ,
diphenylsilyl(cyclopentadienyl)(9-fluorenyl)zirconium Xₙ,
diphenylsilylbis(indenyl)zirconium Xₙ,
cyclotrimethylenesilyl(tetramethylcyclopentadienyl) (cyclopentadienyl)zirconium cyclotetramethylenesilyl(tetramethylcyclopentadienyl)(cyclopentadienyl) zirconium Xₙ,
cyclotrimethylenesilyl(tetramethylcyclopentadienyl)(2-methylindenyl)zirconium
cyclotrimethylenesilyl(tetramethylcyclopentadienyl) (3-methylcyclopentadienyl)zirconium Xₙ,
cyclotrimethylenesilylbis(2-methylindenyl)zirconium Xₙ,
cyclotrimethylenesilyl(tetramethylcyclopentadienyl)(2,3 ,5-trimethylcyclopentadienyl)zirconium Xₙ,
cyclotrimethylenesilylbis(tetramethylcyclopentadienyl)zirconium Xₙ,
dimethylsilyl(tetramethylcyclopentadieneyl)(N-tert-butylamido)titanium Xₙ,
bis(cyclopentadienyl)chromium Xₙ,
bis(cyclopentadienyl)zirconium Xₙ,
bis(n-butylcyclopentadienyl)zirconium Xₙ,
bis(n-dodecyclcyclopentadienyl)zirconium Xₙ,
bis(ethylcyclopentadienyl)zirconium Xₙ,
bis(iso-butylcyclopentadienyl)zirconium Xₙ,
bis(iso-propylcyclopentadienyl)zirconium Xₙ,
bis(methylcyclopentadienyl)zirconium Xₙ,
bis(n-oxtylcyclopentadienyl)zirconium Xₙ,
bis(n-pentylcyclopentadienyl)zirconium Xₙ,
bis(n-propylcyclopentadienyl)zirconium Xₙ,
bis(trimethylsilylcyclopentadienyl)zirconium Xₙ,
bis(1,3-bis(trimethylsilyl)cyclopentadienyl)zirconium Xₙ,
bis(1-ethyl-2-methylcyclopentadienyl)zirconium Xₙ,
bis(1-ethyl-3-methylcyclopentadienyl)zirconium Xₙ,
bis(pentamethylcyclopentadienyl)zirconium Xₙ,
bis(pentamethylcyclopentadienyl)zirconium Xₙ,
bis(1-propyl-3-methylcyclopentadienyl)zirconium Xₙ,
bis(1-n-butyl-3-methylcyclopentadienyl)zirconium Xₙ,
bis(1-isobutyl-3-methylcyclopentadienyl)zirconium Xₙ,
bis(1-propyl-3-butylcyclopentadienyl)zirconium Xₙ,
bis(1-n-butyl-3-n-butylcyclopentadienyl)zirconium Xₙ,
bis (1,3-methyl-n-butylcyclopentadienyl) zirconium Xₙ,
bis(4,7-dimethylindenyl)zirconium Xₙ,
bis(indenyl)zirconium Xₙ,
bis(2-methylindenyl)zirconium Xₙ,
cyclopentadienylindenylzirconium Xₙ,
(tetramethyl cyclopentadienyl) (n-propyl cyclopentadienyl) zirconium Xₙ,
(pentamethyl cyclopentadienyl) (n-propyl cyclopentadienyl) zirconium Xₙ,
bis(n-propylcyclopentadienyl)hafnium Xₙ,
bis(n-butylcyclopentadienyl)hafnium Xₙ,
bis(n-pentylcyclopentadienyl)hafnium Xₙ,
(n-propyl cyclopentadienyl)(n-butyl cyclopentadienyl)hafnium Xₙ,
bis[(2-trimethylsilylethyl)cyclopentadienyl]hafnium Xₙ,
bis(trimethylsilyl cyclopentadienyl)hafnium Xₙ,
bis(2-n-propylindenyl)hafnium Xₙ,
bis(2-n-butylindenyl)hafnium Xₙ,
dimethylsilylbis(n-propylcyclopentadienyl)hafnium Xₙ,
dimethylsilylbis(n-butylcyclopentadienyl)hafnium Xₙ,
bis(9-n-propylfluorenyl)hafnium Xₙ,
bis(9-n-butylfluorenyl)hafnium Xₙ,
(9-n-propylfluorenyl)(2-n-propylindenyl)hafnium Xₙ,
bis(1-n-propyl-2-methylcyclopentadienyl)hafnium Xₙ,
(n-propylcyclopentadienyl) (1-n-propyl-3-n-butylcyclopentadienyl)hafnium Xₙ,
dimethylsilyl(tetramethylcyclopentadienyl)(cyclopropylamido)titanium Xₙ,
dimethylsilyl(tetramethyleyclopentadienyl)(cyclobutylamido)titanium Xₙ,
dimethylsilyl(tetramethyleyclopentadienyl)(cyclopentylamido)titanium Xₙ,
dimethylsilyl(tetramethylcyclopentadienyl)(cyclohexylamido)titanium Xₙ,
dimethylsilyl(tetramethylcyclopentadienyl)(cycloheptylamido)titanium Xₙ,
dimethylsilyl(tetramethylcyclopentadienyl)(cyclooctylamido)titanium Xₙ,
dimethylsilyl(tetramethylcyclopentadienyl)(cyclononylamido)titanium Xₙ,
dimethylsilyl(tetramethylcyclopentadienyl)(cyclodecylamido)titanium Xₙ,
dimethylsilyl(tetramethylcyclopentadienyl)(cycloundecylamido)titanium Xₙ,
dimethylsilyl(tetramethylcyclopentadienyl)(cyclododecylamido)titanium Xₙ,
dimethylsilyl(tetramethylcyclopentadienyl)(sec-butylamido)titanium Xₙ,
dimethylsilyl(tetramethylcyclopentadienyl)(n-octylamido)titanium Xₙ,
dimethylsilyl(tetramethylcyclopentadienyl)(n-decylamido)titanium Xₙ,
dimethylsilyl(tetramethylcyclopentadienyl)(n-octadecylamido)titanium Xₙ,
methylphenylsilyl(tetramethylcyclopentadienyl)(cyclopropylamido)titanium Xₙ,
methylphenylsilyl(tetramethylcyclopentadienyl)(cyclobutylamido)titanium Xₙ,
methylphenylsilyl(tetramethylcyclopentadienyl)(cyclopentylamido)titanium Xₙ,
methylphenylsilyl(tetramethylcyclopentadienyl)(cyclohexylamido)titanium Xₙ,
methylphenylsilyl(tetramethylcyclopentadienyl)(cycloheptylamido)titanium Xₙ,
methylphenylsilyl(tetramethylcyclopentadienyl)(cyclooctylamido)titanium Xₙ,
methylphenylsilyl(tetramethylcyclopentadienyl)(cyclononylamido)titanium Xₙ,
methylphenylsilyl(tetramethylcyclopentadienyl)(cyclodecylamido)titanium, Xₙ,
methylphenylsilyl(tetramethylcyclopentadienyl)(cycloundecylamido)titanium Xₙ,
methylphenylsilyl(tetramethylcyclopentadienyl)(cyclododecylamido)titanium Xₙ,
methylphenylsilyl(tetramethylcyclopentadienyl)(sec-butylamido)titanium Xₙ,
methylphenylsilyl(tetramethylcyclopentadienyl)(n-octylamido)titanium Xₙ,
methylphenylsilyl(tetramethylcyclopentadienyl)(n-decylamido)titanium Xₙ,
methylphenylsilyl(tetramethylcyclopentadienyl)(n-octadecylamido)titanium Xₙ,
diphenylsilyl(tetramethylcyclopentadienyl)(cyclopropylamido)titanium Xₙ,
diphenylsilyl(tetramethylcyclopentadienyl)(cyclobutylamido)titanium Xₙ,
diphenylsilyl(tetramethylcyclopentadienyl)(cyclopentylamido)titanium Xₙ,
diphenylsilyl(tetramethylcyclopentadienyl)(cyclohexylamido)titanium Xₙ,
diphenylsilyl(tetramethylcyclopentadienyl)(cycloheptylamido)titanium Xₙ,
diphenylsilyl(tetramethylcyclopentadienyl)(cyclooctylamido)titanium Xₙ,
diphenylsilyl(tetramethylcyclopentadienyl)(cyclononylamido)titanium Xₙ,
diphenylsilyl(tetramethylcyclopentadienyl)(cyclodecylamido)titanium Xₙ,
diphenylsilyl(tetramethylcyclopentadienyl)(cycloundecylamido)titanium Xₙ,
diphenylsilyl(tetramethylcyclopentadienyl)(cyclododecylamido)titanium Xₙ,
diphenylsilyl(tetramethylcyclopentadienyl)(sec-butylamido)titanium Xₙ,
diphenylsilyl(tetramethyleyclopentadienyl)(n-octylamido)titanium Xₙ,
diphenylsilyl(tetramethyleyclopentadienyl)(n-decylamido)titanium Xₙ,
diphenylsilyl(tetramethylcyclopentadienyl)(n-octadecylamido)titaniUM Xₙ, and derivatives thereof,
   wherein the value of n is 1, 2 or 3. The phrase “derivatives thereof” will be understood to mean any substitution or ring formation as described above for structures (Va-d) in one exemplary embodiment; and in particular, replacement of the metal “M” (Cr, Zr, Ti or Hf) with an atom selected from the group consisting of Cr, Zr, Hf and Ti; and replacement of the “X” group with any of C₁ to C₅ alkyls, C₆ aryls, C₆ to C₁₀ alkylaryls, fluorine, chlorine, or bromine.

It is contemplated that the metallocene catalysts components described above include their structural or optical or enantiomeric isomers (racemic mixture), and, in one exemplary embodiment, may be a pure enantiomer.

As used herein, a single, bridged, asymmetrically substituted metallocene catalyst component having a racemic and/or meso isomer does not, itself, constitute at least two different bridged, metallocene catalyst components.

Activator

As used herein, the term “activator” is defined to be any compound or combination of compounds, supported or unsupported, which can activate a catalyst compound (e.g., Ziegler-Natta, metallocenes, Group 15-containing catalysts, etc.), such as by creating a cationic species from the catalyst component. The catalyst components of the present invention are thus activated towards olefin polymerization using such activators. Embodiments of such activators include Lewis acids such as cyclic or oligomeric poly(hydrocarbylaluminum oxides), alkylaluminum compounds and so called non-coordinating ionic activators (“NCA”) (alternately, “ionizing activators” or “stoichiometric activators”), or any other compound that can convert a neutral metallocene catalyst component to a metallocene cation that is active with respect to olefin polymerization.

More particularly, it is within the scope of this invention to use Lewis acids such as alumoxane (e.g., methylaluminoxane, or “MAO”), modified alumoxane (e.g., “TIBAO”), and alkylaluminum compounds as activators, and/or ionizing activators (neutral or ionic) such as tri (n-butyl)ammonium tetrakis(pentafluorophenyl)boron and/or a trisperfluorophenyl boron metalloid precursors to activate desirable metallocenes described herein. MAO and other aluminum-based activators are well known in the art. Ionizing activators are well known in the art. The activators may be associated with or bound to a support, either in association with the catalyst component (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Non-limiting examples of aluminum alkyl compounds that may be utilized as activators in the methods of the present invention include trimethylaluminum, triethylaluminum, triisobutylaluminum, tri-n-hexylaluminum, tri-n-octylaluminum and the like.

Examples of neutral ionizing activators include Group 13 tri-substituted compounds, in particular, tri-substituted boron, tellurium, aluminum, gallium and indium compounds, and mixtures thereof. The three substituent groups are each independently selected from the group consisting of alkyls, alkenyls, halogen, substituted alkyls, aryls, arylhalides, alkoxy and halides. In one embodiment, the three groups are independently selected from the group consisting of halogen, mono or multicyclic (including halosubstituted) aryls, alkyls, and alkenyl compounds and mixtures thereof. In another embodiment, the three groups are selected from the group consisting of alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls), and combinations thereof. In yet another embodiment, the three groups are selected from the group consisting of alkyls having 1 to 4 carbon groups, phenyl, naphthyl and mixtures thereof. In yet another embodiment, the three groups are selected from the group consisting of highly halogenated alkyls having 1 to 4 carbon groups, highly halogenated phenyls, and highly halogenated naphthyls and mixtures thereof. By “highly halogenated”, it is meant that at least 50% of the hydrogens are replaced by a halogen group selected from the group consisting of fluorine, chlorine and bromine. In another embodiment, the neutral tri-substituted Group 13 compounds are boron compounds.

Illustrative, non-limiting examples of ionic ionizing activators include trialkyl-substituted ammonium salts such as triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-tri-fluoromethylphenyl)boron, tributylammonium tetra(pentafluorophenyl)boron, tri(n-butyl)ammonium tetra(o-tolyl)boron and the like; N,N-dialkyl anilinium salts such as N,N-dimethylanilinium tetra(phenyl)boron, N,N-diethylanilinium tetra(phenyl) boron, N,N-2,4,6-pentamethylanilinium tetra(phenyl)boron and the like; dialkyl ammonium salts such as di-(isopiopyl)ammonium tetra(pentafluorophenyl)boron, dicyclohexylammonium tetra(phenyl)boron and the like; and triaryl phosphonium salts such as triphenylphosphonium tetra(phenyl)boron, tri(methylphenyl)phosphonium tetra(phenyl)boron, tri(dimethylphenyl)phosphonium tetra(phenyl)boron and the like, and their aluminum equivalents.

Other activators include those described in WO 98/07515 such as tris (2, 2′,2″- nonafluorobiphenyl) fluoroaluminate. Combinations of activators also are contemplated by the invention, for example, alumoxanes and ionizing activators in combinations. Other activators include aluminum/boron complexes, perchlorates, periodates and iodates including their hydrates; lithium (2,2′-bisphenyl-ditrimethylsilicate).4THF; silylium salts in combination with a non-coordinating compatible anion. Also, methods of activation such as using radiation, electro-chemical oxidation, and the like also are contemplated as activating methods for the purposes of rendering the neutral metallocene-type catalyst compound or precursor to a metallocene-type cation capable of polymerizing olefins.

In general, the activator and catalyst component(s) are combined in mole ratios of activator to catalyst component from 1000:1 to 0.1:1 in one embodiment, and from 300:1 to 1:1 in a more particular embodiment, and from 150:1 to 1:1 in yet a more particular embodiment, and from 50:1 to 1:1 in yet a more particular embodiment, and from 10:1 to 0.5:1 in yet a more particular embodiment, and from 3:1 to 0.3:1 in yet a more particular embodiment, wherein a desirable range may include any combination of any upper mole ratio limit with any lower mole ratio limit described herein. When the activator is a cyclic or oligomeric poly(hydrocarbylaluminum oxide) (e.g., “MAO”), the mole ratio of activator to catalyst component ranges from 2:1 to 100,000:1 in one embodiment, and from 10:1 to 10,000:1 in another embodiment, and from 50:1 to 2,000:1 in a more particular embodiment. When the activator is a neutral or ionic ionizing activator such as a boron alkyl and the ionic salt of a boron alkyl, the mole ratio of activator to catalyst component ranges from 0.5:1 to 10:1 in one embodiment, and from 1:1 to 5:1 in yet a more particular embodiment.

More particularly, the molar ratio of Al/metallocene-metal (Al from MAO) ranges from 80 to 180 in one embodiments, and from 120 to 180 in another embodiment.

Support Material

The terms “support” or “carrier”, as used herein, are used interchangeably and refer to any support material, including inorganic or organic support materials. In one exemplary embodiment, the support material may be a porous support material. Non-limiting examples of support materials include inorganic oxides and inorganic chlorides, and in particular such materials as talc, clay, silica, alumina, magnesia, zirconia, iron oxides, boria, calcium oxide, zinc oxide, barium oxide, thoria, aluminum phosphate gel, and polymers such as polyvinylchloride and substituted polystyrene, functionalized or crosslinked organic supports such as polystyrene divinyl benzene polyolefins or polymeric compounds, and mixtures thereof, and graphite, in any of its various forms. In certain preferred embodiments of the present invention, the support material is fumed silica commercially available from Cabot Corporation under the trade name “Cab-O-Sil” TS-610.

The support may be contacted with the other components of the catalyst system in any number of ways. In one exemplary embodiment, the support is contacted with the activator to form an association between the activator and support, or a “bound activator”. In another exemplary embodiment, the catalyst component may be contacted with the support to form a “bound catalyst component”. In yet another exemplary embodiment, the support may be contacted with the activator and catalyst component together, or with each partially in any order. The components may be contacted by any suitable means as in a solution, slurry, or solid form, or some combination thereof. In certain exemplary embodiments, the components may also be heated to a temperature in the range of from 25° C. to 250° C. while being contacted.

Desirable carriers are inorganic oxides that include Group 2, 3, 4, 5, 13 and 14 oxides and chlorides. Support materials include silica, alumina, silica-alumina, magnesium chloride, graphite, and mixtures thereof in one exemplary embodiment. Other useful supports include magnesia, titania, zirconia, montmorillonite (as described in EP 0 511 665 B1), phyllosilicate, and the like. In certain exemplary embodiments, combinations of the support materials may be used, including, but not limited to, combinations such as silica-chromium, silica-alumina, silica-titania, and the like. Additional support materials may include those porous acrylic polymers described in EP 0 767 184 B 1.

In certain embodiments, the support material has an average particle size of less than about 10 micrometer, preferably less than about 1 micrometer, and most preferably has an average particle size in the range of from about 0.001 to about 0.1 micrometers.

Preparation of Catalyst Compositions

In one embodiment, the catalyst compositions used in the present invention are prepared by forming a well-stirred suspension of support material, one or more metallocene catalysts and one or more activators in one or more suitable diluents, and then spray drying the suspension. Typically, in preparing the suspension, the support material is added to a solution or dispersion of the activator to form a first suspension. The first suspension is stirred for approximately 20 to 60 minutes, and then a solution or dispersion of the metallocene catalyst is added thereto. The resulting final suspension is stirred for a further 20 to 60 minutes and then spray dried. The same or different diluents may be used for the metallocene catalyst and the activator.

The diluent employed in forming the suspension is typically a material capable of dissolving or suspending the metallocene catalyst and the activator, and suspending the support material. For example, hydrocarbons such as linear or branched alkanes including n-hexane, n-pentane and isopentane; aromatics such as toluene and xylene; and halogenated hydrocarbons such as dichloromethane are useful as the diluent. In certain preferred embodiments, the diluent may have a boiling point from about 0 degrees to about 150 degrees Celsius.

Preferably, spray drying is performed by spraying the suspension through a heated nozzle into a stream of heated inert drying gas, such as nitrogen, argon, or propane to evaporate the diluent and produce solid-form particles of metallocene catalyst and activator in a matrix of support material. The volumetric flow of the drying gas is preferably considerably larger than the volumetric flow of the suspension. Atomization of the suspension may be accomplished using an atomizing nozzle or a centrifugal high speed disc atomizer.

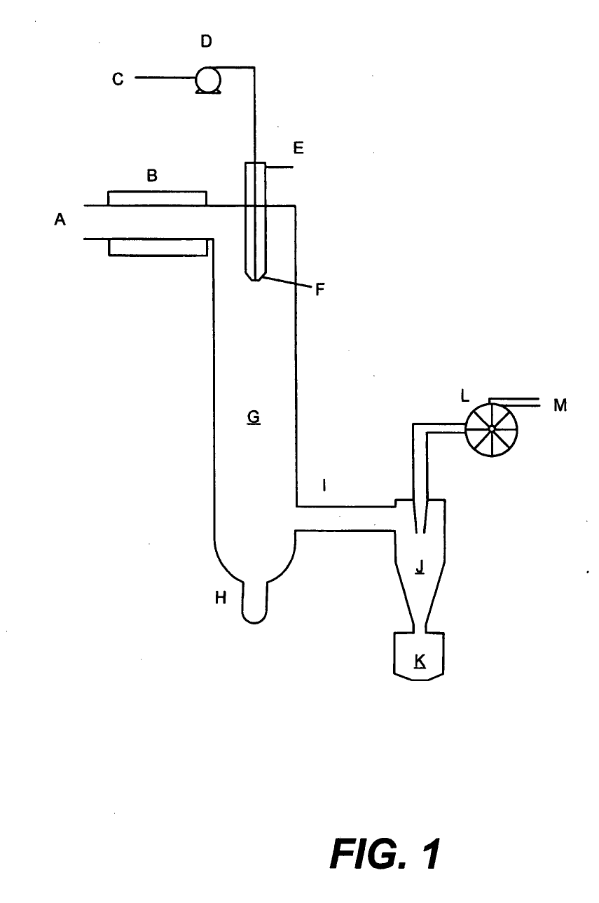

For example, in certain embodiments of the present invention, spray drying may be performed in accordance with the exemplary system that is illustrated in FIG. 1. Referring now to FIG. 1, in certain embodiments, the final suspension may be flowed through a reservoir attached at point C (e.g., by a peristaltic pump D). As the suspension passes through atomizing nozzle F, it may be mixed with atomizing gas (which atomizing gas may enter the system at point E, for example). The temperature of atomizing nozzle F may be at, or above, the boiling point of the highest boiling component of the final suspension. The mist of catalyst composition thus formed in drying chamber G then may dry in the presence of heated inert drying gas, which may enter the drying chamber G at point A, and which may be heated by heater B before entering. Any spray-dried catalyst particles having an undesirably large diameter may fail to be entrained in the flow of heated inert drying gas, and may be dropped into an oversize collection pot H. The remainder of the spray-dried catalyst particles may continue through drying chamber outlet I into cyclone separator J, wherein the spray-dried catalyst particles may disengage from the gas stream, and may drop into removable product collection pot K, from which the spray-dried catalyst particles may be recovered. The drying gas may be drawn through an aspirator L, and may be removed from the system at point M. Another example of a suitable process for spray-drying particles is described, for example, in U.S. Pat. No. 5,290,745.

The amounts of metallocene catalyst and activator employed in the suspension of metallocene catalyst, activator and support material are as follows. When the activator is a branched or cyclic oligomeric poly(hydrocarbylaluminum oxide), the mole ratio of aluminum atoms (from the activator) to transition metal (from the metallocene catalyst) in the suspension is between about 10 and about 5000, preferably about 50 to about 1000, and most preferably about 100 to about 500.

The amount of support employed in forming the suspension is from about 1 to about 80 percent by weight, preferably about 10 to about 60 percent by weight, and most preferably about 20 to about 50 percent by weight, based on the total weight of the catalyst composition.

The spray dried, filled catalyst composition may optionally contain an organic or inorganic compound as a binder so that particle integrity is further enhanced. The binder may also serve a second function, such as stabilizing the final polyolefin product against oxidation, or improving the gas phase fluidization of nascent polymer particles. Such compounds are well known in the art.

The spray dried, filled catalyst composition is a particulate material containing at least one activator and at least one metallocene catalyst in a matrix of at least one inert support material. The particles of catalyst composition have an average particle size of 5 to 500, preferably 10 to 80, micrometers. The catalyst composition may be mixed with a suitable protective material such as mineral oil for storage.

The catalyst composition may be used in the polymerization of ethylene and optionally higher alpha-olefin monomers, i.e., having 3 to about 8 carbon atoms, into ethylene homopolymers and copolymers.

In an exemplary embodiment, the supported catalyst(s) are treated by combining them with the activators, and further combining them with up to 4.0 wt % (by weight of the catalyst composition) of an antistatic agent, such as an ethoxylated or methoxylated amine, an example of which is Atmer AS-990 (available from Ciba of Tarrytown, N.Y.). In another exemplary embodiment, the supported catalyst(s) are treated by combining them with the activators, and further combining them with up to 4.0 wt % (by weight of the catalyst composition) of a carboxylate metal salt, such as an aluminum mono, di- or tri-stearate. In yet another exemplary embodiment, the supported catalyst(s) are treated by combining them with the activators, and further combining them with up to 4.0 wt % (by weight of the catalyst composition) of a combination of an antistatic agent and a carboxylate metal salt (e.g., 2 wt % of the antistatic agent and 2 wt % of the carboxylate metal salt in some embodiments, or 3 wt % of the antistatic agent and 1 wt % of the carboxylate metal salt in some embodiments, or 1 wt % of the antistatic agent and 3 wt % of the carboxylate metal salt in some embodiments, or the like). In certain other exemplary embodiments of the present invention, the concentrations of MAO and metallocene in the catalyst composition are optimized such that the antistatic agent and/or carboxylate metal salt are present in an amount less than 4.0 wt %, such as, for example, 2 wt % (e.g., a combination of 1 wt % of the antistatic agent and 1 wt % of the carboxylate metal salt in some embodiments, or 2 wt % of the antistatic agent and 0 wt % of the carboxylate metal salt in some embodiments, or 0 wt % of the antistatic agent and 2 wt % of the carboxylate metal salt in some embodiments, or the like). In still other exemplary embodiments of the present invention, the concentrations of MAO and metallocene in the catalyst composition are optimized such that the antistatic agent is absent or substantially absent from the catalyst composition.

Gas Phase Polymerization Process

The polymerization process may be conducted in the gas phase in a stirred or fluidized bed reactor, or in a slurry phase reactor using equipment and procedures well known in the art. Ethylene monomer and optionally one or more higher alpha-olefin monomers (e.g., a co-monomer selected from the group consisting of C4 to C8 alpha olefins) are contacted with an effective amount of catalyst composition at a temperature and a pressure sufficient to initiate polymerization, for a time sufficient to form a polyolefin composition. The process may be carried out in a single reactor or in two or more reactors in series. The process is conducted substantially in the absence of catalyst poisons such as moisture, oxygen, carbon dioxide, and acetylene, since only minor amounts (e.g., less than or equal to 2 ppm) of such materials have been found to affect the polymerization adversely.

The one or more reactor pressures in a gas phase process (either single stage or two or more stages) may vary from 100 psig (690 kPa) to 500 psig (3448 kPa), and in the range of from 200 psig (1379 kPa) to 400 psig (2759 kPa) in another embodiment, and in the range of from 250 psig (1724 kPa) to 350 psig (2414 kPa) in yet another embodiment.

Conventional additives may be included in the process. When hydrogen is used as a chain transfer agent in the process, it is used in amounts varying between about 0.001 to about 10 moles of hydrogen per mole of ethylene plus comonomer. Also, as desired for temperature control of the system, any materials inert to the catalyst composition and reactants can also be present in the system.

Generally, an external co-catalyst is not used in the methods of the present invention, and accordingly, an external co-catalyst generally is absent or substantially absent from the gas-phase reactor during the gas-phase polymerization process. Generally, the slurry or gas phase process is operated in the presence of a spray-dried bulky ligand metallocene-type catalyst system of the invention and in the absence of, or essentially free of, any external co-catalysts, such as triethylaluminum, trimethylaluminum, tri-isobutylaluminum and tri-n-hexylaluminum and diethyl aluminum chloride, dibutyl zinc and the like. By “essentially free”, it is meant that these compounds are not deliberately added to the reactor or any reactor components, and if present, are present to less than 1 ppm in the reactor.

The spray dried, filled catalyst composition has good activity in both fluidized bed reactors and slurry reactors. In particular, the activity of the spray dried, filled catalyst composition is comparable to that of both supported and unsupported (e.g., in solution) metallocene catalysts. Polymer Product of the Invention

The polyolefins made according to the methods of the present invention may be blended with additives to form compositions that can then be used in articles of manufacture. Those additives include antioxidants, nucleating agents, acid scavengers, plasticizers, stabilizers, anticorrosion agents, blowing agents, other ultraviolet light absorbers such as chain-breaking antioxidants, etc., quenchers, antistatic agents, slip agents, pigments, dyes and fillers and cure agents such as peroxide. These and other common additives in the polyolefin industry may be present in polyolefin compositions from 0.01 to 50 wt % in one exemplary embodiment, and from 0.1 to 20 wt % in another exemplary embodiment, and from 1 to 5 wt % in yet another exemplary embodiment, wherein a desirable range may include any combination of any upper wt % limit with any lower wt % limit.

In particular, antioxidants and stabilizers such as organic phosphites, hindered amines, and phenolic antioxidants may be present in the polyolefin compositions of the invention from 0.001 to 5 wt % in one exemplary embodiment, from 0.01 to 0.8 wt % in another exemplary embodiment, and from 0.02 to 0.5 wt % in yet another exemplary embodiment. Non-limiting examples of organic phosphites that are suitable are tris(2,4-di-tert-butylphenyl)phosphite (IRGAFOS 168) and di(2,4-di-tert-butylphenyl)pentaerithritol diphosphite (ULTRANOX 626). Non-limiting examples of hindered amines include poly[2-N,N′-di(2,2,6,6-tetramethyl-4-piperidinyl)-hexanediamine-4-(1-amino-1,1,3,3- tetramethylbutane)symtriazine](CHIMASORB 944); bis (1,2,2,6,6-pentamethyl-4-piperidyl)sebacate (TINUVIN 770). Non-limiting examples of phenolic antioxidants include pentaerythrityl tetrakis(3,5-di-tert-butly-4-hydroxyphenyl) propionate (IRGANOX 1010); and 1,3,5-Tri(3,5-di-tert-butyl-4-hydroxybenzyl-isocyanurate (IRGANOX 3114).

Fillers may be present from 0.1 to 50 wt % in one exemplary embodiment, and from 0.1 to 25 wt % of the composition in another exemplary embodiment, and from 0.2 to 10 wt % in yet another exemplary embodiment. Desirable fillers include, but are not limited to, titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, talc and hydrotalcite compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous and brominated flame retardants, antimony trioxide, silica, silicone, and blends thereof. These fillers may particularly include any other fillers and porous fillers and supports known in the art.

Fatty acid salts may also be present in the polyolefin compositions of the present invention. Such salts may be present from 0.001 to 2 wt % of the composition in one exemplary embodiment, and from 0.01 to 1 wt % in another exemplary embodiment. Examples of fatty acid metal salts include lauric acid, stearic acid, succinic acid, stearyl lactic acid, lactic acid, phthalic acid, benzoic acid, hydroxystearic acid, ricinoleic acid, naphthenic acid, oleic acid, palmitic acid, and erucic acid, suitable metals including Li, Na, Mg, Ca, Sr, Ba, Zn, Cd, Al, Sn, Pb and so forth. Desirable fatty acid salts are selected from magnesium stearate, calcium stearate, sodium stearate, zinc stearate, calcium oleate, zinc oleate, and magnesium oleate.

With respect to the physical process of producing the blend of polyolefin and one or more additives, sufficient mixing should take place to assure that a uniform blend will be produced prior to conversion into a finished product. The polyolefin suitable for use in the present invention can be in any physical form when used to blend with the one or more additives. In one exemplary embodiment, reactor granules (defined as the granules of polymer that are isolated from the polymerization reactor) are used to blend with the additives. The reactor granules have an average diameter of from 10 μm to 5 mm, and from 50 μm to 10 mm in another exemplary embodiment. Alternately, the polyolefin is in the form of pellets, such as, for example, pellets having an average diameter of from 1 mm to 6 mm that are formed from melt extrusion of the reactor granules.

One method of blending the additives with the polyolefin is to contact the components in a tumbler or other physical blending means, the polyolefin being in the form of reactor granules. This can then be followed, if desired, by melt blending in an extruder. Another method of blending the components is to melt blend the polyolefin pellets with the additives directly in an extruder, Brabender or any other melt blending means.

The resultant polyolefin and polyolefin compositions of the present invention may be further processed by any suitable means such as by calendering, casting, coating, compounding, extrusion, foaming; all forms of molding including compression molding, injection molding, blow molding, rotational molding, and transfer molding; film blowing or casting and all methods of film formation to achieve, for example, uniaxial or biaxial orientation; thermoforming, as well as by lamination, pultrusion, protrusion, draw reduction, spinbonding, melt spinning, melt blowing, and other forms of fiber and nonwoven fabric formation, and combinations thereof. These and other forms of suitable processing techniques are described in, for example, PLASTICS PROCESSING (Radian Corporation, Noyes Data Corp. 1986).

In the case of injection molding of various articles, simple solid state blends of the pellets serve equally as well as pelletized melt state blends of raw polymer granules, of granules with pellets, or of pellets of the two components, since the forming process includes a remelting and mixing of the raw material. In the process of compression molding of medical devices, however, little mixing of the melt components occurs, and a pelletized melt blend would be preferred over simple solid state blends of the constituent pellets and/or granules. Those skilled in the art will be able to determine the appropriate procedure for blending of the polymers to balance the need for intimate mixing of the component ingredients with the desire for process economy.

The polymers of the present invention, in one exemplary embodiment, have a melt index (MI) or (I₂) as measured by ASTM-D-1238-E (190/2.16) in the range from 0.01 dg/min to 1000 dg/min, more preferably from about 0.01 dg/min to about 100 dg/min, even more preferably from about 0.1 dg/min to about 50 dg/min, and most preferably from about 0.1 dg/min to about 10 dg/min, and even more preferably from 0.1 dg/min to 5 dg/min.

The polymers of the present invention, in one exemplary embodiment, have a melt flow ratio (121/12) (121 is measured by ASTM-D-1238-F, [190/21.6]) of from 10 to 300, more preferably from about 10 to less than 250, and from 15 to 200 in yet another exemplary embodiment, and from 20 to 180 in yet another exemplary embodiment, and from 15 to 30 in yet another exemplary embodiment, and from 10 to 40 in yet another exemplary embodiment, and from 10 to 50 in yet another exemplary embodiment, wherein a desirable range may include any combination of any upper limit with any lower limit.

Common rheological properties, processing methods and end use applications of metallocene based polyolefins are discussed in, for example, 2 METALLOCENE-BASED POLYOLEFINS 400-554 (John Scheirs & W. Kaminsky, eds. John Wiley & Sons, Ltd. 2000). The polyolefinic compositions of the present invention are suitable for such articles as films, fibers and nonwoven fabrics, extruded articles and molded. Examples of films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications, agricultural films and sheets. Examples of fibers include melt spinning, solution spinning and melt blown fiber operations for use in woven or non-woven form to make filters, diaper fabrics, hygiene products, medical garments, geotextiles, etc. Examples of extruded articles include tubing, medical tubing, wire and cable coatings, pipe, geomembranes, and pond liners. Examples of molded articles include single and multi-layered constructions in the form of bottles, tanks, large hollow articles, rigid food containers and toys, etc.

Other desirable articles that can be made from and/or incorporate the polyolefins of the present invention include automotive components, sporting equipment, outdoor furniture (e.g., garden furniture) and playground equipment, boat and water craft components, and other such articles. More particularly, automotive components include such as bumpers, grills, trim parts, dashboards and instrument panels, exterior door and hood components, spoiler, wind screen, hub caps, mirror housing, body panel, protective side molding, and other interior and external components associated with automobiles, trucks, boats, and other vehicles.

Further useful articles and goods may be formed economically or incorporate the polyolefins produced by the practice of our invention, including: crates, containers, packaging material, labware, office floor mats, instrumentation sample holders and sample windows; liquid storage containers for medical uses such as bags, pouches, and bottles for storage and IV infusion of blood or solutions; wrapping or containing food preserved by irradiation, other medical devices including infusion kits, catheters, and respiratory therapy, as well as packaging materials for medical devices and food which may be irradiated by gamma or ultraviolet radiation including trays, as well as stored liquid, particularly water, milk, or juice, containers including unit servings and bulk storage containers.

### EXAMPLES

In order to provide a better understanding of the present invention, including representative advantages thereof, the following examples of some exemplary embodiments are offered. In no way should such examples be read to limit, or to define, the scope of the invention.

Activity for laboratory gas-phase reactions was measured in grams polyethylene/[(mmol metal)(hours) (100 psi ethylene)].

PDI is the Polydispersity Index, which is equivalent to Molecular Weight Distribution (Mw/Mn, where Mw is weight-average molecular weight, and Mn is number average molecular weight). PDI is determined by gel permeation chromatography using crosslinked polystyrene columns; pore size sequence: 1 column less than 1000 Å, 3 columns of mixed 5×10⁷ Å; 1,2,4-trichlorobenzene solvent at 140° C. with refractive index detection.

Kaydol oil, a white mineral oil, was purchased from Witco Corporation, and was purified by degassing with nitrogen for about 1 hour, followed by heating at 80° C. under vacuum for 10 hours.

(PrCp)₂HfCl₂ is bis(n-propylcyclopentadienyl)hafnium dichloride, available from Boulder Scientific Company.

MAO is methylalumoxane in toluene (30 weight percent), available from Albemarle Corporation.

SMAO is silica-supported MAO, and was prepared by the following procedure. A toluene solution of MAO was prepared by mixing 960 grams of 30 wt % MAO in 2.7 liters of dry, degassed toluene. This solution was stirred at ambient temperature, while 850 grams of silica gel (Ineos 757, dehydrated at 600° C.) was added. The resulting slurry was stirred at ambient temperature for about 1 hour, and the solvent was removed under reduced pressure with a stream of nitrogen at 85° C. The drying continued until the temperature of the material remained constant for 2 hours. The resulting free-flowing white powder demonstrated an aluminum loading of about 4.67 mmol Aluminum per gram of solid.

Preparation of Sample Catalyst Compositions Nos. 1 and 2

Sample Catalyst Composition No. 1 was prepared by mixing 25 grams of bis(n-propylcyclopentadienyl)hafnium dichloride with 6.39 kilograms of a 10% solution by weight of MAO in toluene, and with 0.91 kilograms of fumed silica (Cabosil TS-610). The metallocene, MAO-in-toluene solution, and fumed silica were introduced into an atomizing device, thereby producing droplets that were contacted with a gas stream to evaporate the liquid, thereby forming a powder. The actual yield was about 1.5 kilograms. Neglecting residual toluene in the spray-dried product, the theoretical product weight was calculated to be 1.57 kilograms.

Sample Catalyst Composition No. 2, a comparative sample, was prepared according to the following procedure. A Kaydol oil solution was provided comprising 0.040 grams of (PrCp)₂HfCl₂ (0.0863 mmol) in 18.3 grams of Kaydol oil. About 2.223 grams of SMAO were added to the Kaydol oil solution. The resulting slurry then was stirred for about 16 hours at room temperature. The solid catalyst was recovered by first filtering off the oil, and then washing three times with 15 milliliters of hexane, followed by drying at room temperature for about 1 hour. The resulting off-white solid (2.250 grams, 99% yield) demonstrated a final Hf loading of 0.0381 mmol per gram of solid catalyst, and an Al/Hf ratio of about 121.

A comparison of Sample Catalyst Compositions Nos. 1 and 2 is provided in the table below.

TABLE 1

| Catalyst | Aluminum | Aluminum | Hafnium | Hafnium | Al/Hf |
|---|---|---|---|---|---|
| Composition | (wt %) | (mmol/gram) | (wt %) | (mmol/gram) | ratio |
| No. 1 | 16.3 | 6.04 | 0.61 | 0.034 | 178 |
| No. 2 | 12.4 | 4.59 | 0.68 | 0.038 | 121 |

Sample Catalyst Composition Nos. 1 and 2 were reacted in a laboratory gas phase reactor (1.65 liter, stainless steel autoclave, equipped with a variable-speed mechanical agitator, and normally operated at a 45° angle from vertical during polymerization) according to the following procedure. Typically, the reactor first was charged with about 200 grams of NaCl, and dried by heating at 95° C. under a stream of dry nitrogen for 60 minutes. After cooling to 80° C., 3.0 grams SMAO were added to scavenge impurities.

Because the MAO (in the SMAO) is anchored on the silica support, the MAO generally does not react with Sample Catalyst Compositions Nos. 1 or 2 within the gas phase reactor. Rather, the SMAO interacts primarily with materials of relatively greater mobility (e.g., moisture, air, and other liquid impurities). In accordance with the present invention, the SMAO was not pre-mixed with the supported Sample Catalyst Compositions Nos. 1 or 2, but rather was added in an early stage of reactor conditioning.

The reactor then was sealed, and the components were stirred gently. Pre-filled hydrogen and 1-hexene were pushed in with an ethylene flow; the H₂/C₂ ratio was 0.0012, and the C₆/C₂ ratio was 0.015. The reactor then was heated to a specified polymerization temperature, and pressured to a total pressure of 250 psi with ethylene. The ethylene partial pressure was about 210 psi. Once steady state was reached, about 0.020 grams of a sample catalyst composition (as specified in Table 2 below) was pressured in with a nitrogen flow to begin polymerization. Heating was continued to maintain the specified polymerization temperature. Unless otherwise noted, polymerization was continued for 60 minutes, during which time ethylene, hydrogen, and 1-hexene continually were added to the reactor to maintain a constant total pressure of 250 psi. After 60 minutes, the reactor was vented and opened. The sample was weighed, washed several times with water to remove NaCl, and dried in a vacuum oven at 80° C. overnight.

The results of the reactions described above are set forth in the tables below:

TABLE 2

| | | Temp | | % | | | | |
|---|---|---|---|---|---|---|---|---|
| Run | Catalyst | (C.) | Activity | Improvement | MI | MFR | Mw | PDI |
| 1 | Sample Catalyst | 75 | 93,016 | 57 | 1 | 25 | 123,293 | 3.2 |
| | Composition No. 1 | | | | | | | |
| C1 | Sample Catalyst | 75 | 59,210 | — | 0.9 | 34 | 138,010 | 3.8 |
| | Composition No. 2 | | | | | | | |
| 2 | Sample Catalyst | 85 | 116,590 | 68 | 1.2 | 20 | 117,247 | 2.7 |
| | Composition No. 1 | | | | | | | |
| C2 | Sample Catalyst | 85 | 69,276 | — | 1 | 22 | 120,610 | 3 |
| | Composition No. 2 | | | | | | | |

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the scope of the present invention. Further, certain features of the present invention are described in terms of a set of numerical upper limits and a set of numerical lower limits. It should be appreciated that ranges formed by any combination of these limits are within the scope of the invention unless otherwise indicated.

Unless otherwise indicated, all numbers expressing quantities of ingredients, properties, reaction conditions, and so forth, used in the specification and claims are to be understood as approximations based on the desired properties sought to be obtained by the present invention, and the error of measurement, etc., and should at least be construed in light of the number of reported significant digits and by applying ordinary rounding techniques. Notwithstanding that the numerical ranges and values setting forth the broad scope of the invention are approximations, the numerical values set forth are reported as precisely as possible.

What is claimed is:

1. A gas phase process for making polyolefins, comprising:
(a) forming a suspension comprising (i) a metallocene catalyst, (ii) an activator; and (iii) a support material, in a diluent;
(b) spray-drying the suspension to form a catalyst composition; and
(c) contacting the catalyst composition with ethylene and at least one comonomer selected from the group consisting of C4 to C8 alpha olefins in the fluidized bed of a gas-phase reactor for a time sufficient to form a polyolefin composition, wherein an external co-catalyst is absent or substantially absent from the gas-phase reactor.

2. The process of claim 1, wherein the metallocene catalyst comprises hafnium.

3. The process of claim 1, wherein the metallocene catalyst is represented by the following formula:
Cp₂HfX₂
wherein each Cp is independently a cyclopentadienyl, indenyl or tetrahydroindenyl, characterized in that at least one Cp is substituted with a group selected from the group consisting of halogens, C₁ to C₂₀ alkyls, C₁ to C₂₀ alkoxys, C₅ to C₂₀ arylalkyls, C₅ to C₂₀ alkylaryls, and combinations thereof; and
X is an anionic leaving group.

4. The process of claim 1, wherein the metallocene catalyst is represented by the following formula:
Cp₂HfX₂
wherein Cp is a cyclopentadienyl, characterized in that at least one Cp is substituted with a group selected from the group consisting of halogens, C₁ to C₁₀ alkyls, C₁ to C₂₀ alkoxys, C₅ to C₂₀ arylalkyls, C₅ to C₂₀ alkylaryls, and combinations thereof; and
X is an anionic leaving group selected from the group consisting of halides and C₁ to C₁₀ alkyls.

5. The process of claim 1, wherein the activator is methylaluminoxane.
